(19) United States
(12) Patent Application Publication
(10) Pub. No.: US 2017/0167008 A1
(43) Pub. Date: Jun. 15, 2017

(54) SOLUTION HEAT TREATMENT METHOD FOR MANUFACTURING METALLIC COMPONENTS OF A TURBO MACHINE

(71) Applicant: ANSALDO ENERGIA SWITZERLAND AG, Baden (CH)

(72) Inventors: Martin SCHNEIDER, Ennetbaden (CH); Martin BALLIEL, Bassersdorf (CH)

(73) Assignee: ANSALDO ENERGIA SWITZERLAND AG, Baden (CH)

(21) Appl. No.: 15/373,161

(22) Filed: Dec. 8, 2016

(30) Foreign Application Priority Data
Dec. 10, 2015 (EP) 15199081.9

(51) Int. Cl. C22F 1/10; F01D 25/14; F01D 25/00; F01D 5/14; F01D 9/04

(52) U.S. Cl. CPC C22F 1/10; F01D 5/147; F01D 9/041; F01D 25/005; F01D 25/145; F05D 2230/40; F05D 2300/175

(57) ABSTRACT

A solution heat treatment method is disclosed for manufacturing metallic components of a turbo machine, which components provide a hot gas flow channel when assembled in the turbo machine after manufacturing, wherein the components are subjected to a time-temperature-cycle in a furnace. The method includes positioning the components in the furnace in a same principle as the component assembly in the turbo machine, but leaving flow areas and gaps between neighbouring components; then starting the time-temperature-cycle; and applying an inert gas during the solution heat treatment process so that the inert gas flows through flow areas and gaps for achieving a uniform temperature.

### BACKGROUND OF THE INVENTION

The present invention relates to the technology of manufacturing/heat treating metallic components. It refers to a solution heat treatment method for manufacturing components, especially of a turbo machine, for example a gas turbine according to the preamble of claim 1. Such gas turbine components are for example turbine blades, vanes, or heat shields, especially cooled components.

### PRIOR ART

Such gas turbine components are subjected to a high thermo-mechanical loading and are usually made of super alloys, for example Nickel-based or Cobalt-based super alloys. The ductility (deformability) of single crystal (SX) and directionally solidified (DS) superalloys is lower than in conventionally cast (CC) parts. In regions of high multiaxiality of a component, the low ductility of SX and DS materials is further reduced.

On the other hand, the thermo-mechanical loading of turbine blades requires a certain degree of ductility (deformability) due to thermal strains and high mechanical loads.

Considering that the loading of turbine blades (due to pressure and centrifugal loads and non-even temperature distributions) produces mechanical strains in the order of up to 1%, a considerable ductility of the material is required.

The document U.S. Pat. No. 5,451,142 describes a method to provide a layer/coating of a high strength polycrystalline super alloy bonded to the root of a nickel-base super alloy turbine blade. This layer is plasma sprayed onto the fir tree of the blade.

The document U.S. Pat. No. 4,921,405 teaches a single crystal turbine blade having a portion of its attachment section (fir tree) layered with a fine grained polycrystalline alloy. According to the teaching, the layering is preferably accomplished by plasma spraying of the attachment section with a super alloy and by hot isostatically compacting the sprayed super alloy to minimum porosity. The resulting turbine blade should have improved life resulting from the reduced low cycle, low temperature fatigue susceptibility of, and crack growth in, the composite attachment section.

In both cases, a special coating process has to be applied during manufacturing of the blade, which requires substantial additional time and cost efforts.

Document U.S. Pat. No. 4,582,548 describes a single crystal casting alloy for use in a gas turbine engine. Single crystal solid blades or bars were cast and machined in the longitudinal direction. After machining they were subjected under a solution heat treatment and then they were pseudo-coated and aged. EP 1184473 A2 discloses Nickel-base single-crystal super alloys and a method of manufacturing the same. The method is similar to the one described in U.S. Pat. No. 4,582,548, that means that the solution heat treatment of the specimen/component and the additional heat treatment steps are done after a machining step.

Document US 2015/0013852 A discloses an improved method for manufacturing a gas turbine component made of a SX or DS nickel base super alloy, comprising a heat treatment (HTS1-3) and a machining and/or mechanical treatment step (SM), wherein said machining/mechanical treatment step (SM) is done prior to said heat treatment (HTS1-3). It is characterised in that a solution heat treatment (SHT) of the component (11) is done prior to said machining/mechanical treatment step (SM). Plastic deformation and machining of the final specimen geometry (machining step SM) has been done before the heat treatment (heat treatment steps HTS1-3), but after the solution heat treatment. Thereby, the surface near region, previously affected by plastic deformation and machining (e.g. by cold work hardening, for instance) was modified by the heat treatment. Significant higher ductility was achieved due to previous surface treatment (plastic deformation). The effect of increased ductility on SX components has also been observed on other specimens at room temperature as well as at 600° C. even without previous plastic deformation, only due to the specimen machining step (SM).

In general, a solution heat treatment is a temperature and time dependent process with a certain time-temperature-cycle. A solution heat treatment for DS or SX components is a stepwise increase/decrease of process temperature and hold times primarily to achieve the required yield strength of the material. The maximum temperature, the hold time at that maximum temperature and the cooling rates determine the achievable yield strength and other mechanical properties.

Unfortunately, the solution heat treatment process has some process variations since the heat treatment is not well controlled in the furnace because of variations in the geometrical design of the components, in their positions in the furnace, in the inert gas flow rate and direction, in locally non-uniform absolute heat capacity/thermal inertia of a complex shaped component. It is known that solution heat treatment can be done with ceramic cores in the components and possibly with shell mould remainders, or without cores in the components and without a shell mould.

Especially for gas turbine components, like turbine blades comprising a root and an airfoil, it is very difficult to achieve a uniform temperature at any time in the solution heat treatment process, in particular during (rapid) cool-down and heat-up phases. The term root in this context and in the context of this application includes the attachment area to the turbine rotor (usually a fir tree shape), the shank (connection between attachment area to the turbine rotor and inner platform/shroud) and the inner platform or inner shroud (separating the shank from the hot gas). The fir-tree root is not yet machined and has a high thermal inertia while the airfoil has a low thermal inertia. There are inlet holes, a cooling geometry inside, and outlet holes. During operation of the turbine the components form an internal (cooling) and an external (hot gas) flow channel together with the similar neighbouring components to channel flow in the intended flow direction and extract work, or to prevent flow to flow in a certain flow direction.

In prior art the requirement for a minimum cooling rate and the risk of plastic deformation due to excessive temperature gradients during rapid cooling can be conflicting. Additionally, hold times at elevated temperatures may vary within a component, as a thin section reaches the hold temperature earlier than a thick section, consequently there could be a risk that a hold time in a thick section is too short to achieve required material properties, e.g. due to an insufficient (low) degree of solutioning.

### SUMMARY OF THE INVENTION

It is an object of the present invention to disclose an improved solution heat treatment method to achieve a substantially improved temperature uniformity at any time and in particular during the (rapid) cool-down and heat-up phases of the solution heat treatment for manufacturing metallic components of a turbo machine, especially of a gas turbine.

This and other objects are obtained by a method according to claim 1.

The method is characterized in
positioning the components in the furnace in the same principle as the component assembly in the turbo machine, but leaving flow areas and gaps between neighbouring components, then
starting the time-temperature-cycle of the solution heat treatment, and
applying an inert gas during the solution heat treatment process, so that the inert gas flows through said flow areas and gaps for achieving a uniform temperature at any time in the solution heat treatment process, in particular during (rapid) cool-down and heat-up phases.

With the inventive method a better controlled solution heat treatment process is achieved by positioning/installation of the components in the furnace in the disclosed manner while applying an inert gas flow. This “external” inert gas flow decreases the mismatches in flow conditions within the furnace, so that a more uniform temperature distribution and therefore improved mechanical properties of the treated components are realized. This is for example applicable when cast components with ceramic cores inside are solution heat treated.

A further advantage of the invention is realized when components are solution heat treated according to the described method, wherein said components comprise at least one internal cooling channel, so that—while applying the inert gas during the solution heat treatment process in the furnace—said inert gas flows also through that internal channel. This is for example the case when the ceramic core used in the casting process of the component is removed thereby producing such an internal cooling channel. The combination of this “internal” flow with the described “external” flow decreases further the mismatches in the flow conditions.

In one further embodiment of the described invention each component comprises at least a first part with a first thermal inertia and at least a second part with a second thermal inertia, wherein the first thermal inertia is significantly higher than the second thermal inertia, wherein the second part of each component is wrapped with a wrapping material before positioning the partly wrapped components in the furnace for solution heat treatment. The wrapping material, preferably ceramic felt, ceramic wool or ceramic textile, increases the thermal inertia of the second part and decreases therefore the thermal mismatch between the first and second parts of the component. Thermal conductivity, thickness, location and attachment method of the ceramic material could be easily chosen to achieve the best results.

A better controlled solution heat treatment process is achieved by making use of the shape and condition of the component (wrapping to control the heat flux) and by a positioning/installation of the component in the furnace in the disclosed manner while applying an inert gas flow. The components are subjected to nearly the same flow and thermal conditions in the furnace.

The cooling/heating could be controlled in a more efficient manner, the process variation is reduced and therefore the variation in material properties (for example the yield strength) is decreased from component to component and within a component, in particular during cooling the minimum required cooling rate may not be achieved in a thick section causing insufficient material properties in the thick section. In addition, the risk of plastic deformation during cooling and/or risk of overheating during heat-up of the component due to excessive local temperature gradients caused by local, non-uniform cooling or heating rates is avoided or minimised.

It is an advantage if the components are positioned in the furnace within at least one drawer, comprising an inert gas flow inlet and an inert gas flow outlet. A plurality of components is preferably separated by using several of said drawers, and a pressure difference of the inert gas between the inert gas inlet and the inert gas outlet of the drawer is provided for a controlled flow situation.

According to an embodiment the used drawers comprise a dedicated internal design which is at least partly matched to the design of the components to be solution heat treated.

According to a further embodiment the solution heat treated component is fixed to the drawer by any suitable detachable means.

According to an additional embodiment of the invention the solution heated component is a gas turbine component with or without an internal cooling channel, preferably a turbine blade, a vane, or a heat shield.

According to a preferred embodiment the solution heated components 1 are made of a single crystal (SX) or directionally solidified (DS) super alloy, preferably a Nickel- or Cobalt-based super alloy, but could be also used for components made of a conventionally cast (CC) super alloy, preferably a Nickel- or Cobalt-based super alloy.

### BRIEF DESCRIPTION OF THE DRAWINGS

The present invention is now to be explained more closely by means of different embodiments and with reference to the attached drawings.

FIG. 1 shows a simplified sketch of a turbine blade with a root (first part) and an airfoil (second part) according to the prior art;

FIG. 2 shows a simplified cooling scheme for a blade similar to FIG. 1 (prior art);

FIG. 3 shows a blade with a wrapped airfoil part according to an embodiment of the invention;

FIG. 4 shows schematically an assembly of three turbine blades in a turbo machine;

FIG. 5 shows in a perspective drawing a simplified drawer for installation in the furnace; and

FIG. 6 shows a drawer design with two turbine blades according to a further embodiment of the invention.

### DETAILED DESCRIPTION OF DIFFERENT EMBODIMENTS OF THE INVENTION

In a preferred embodiment, the present invention is based on a combination of conditioning of a complex component, preferably made of a SX/DX-Nickel- or Cobalt-based super alloy, to be solution heat treated in a furnace (by wrapping a part of this component to control the heat flux) with a special positioning and installation of this component in the furnace while applying an inert gas flow. Components made of conventionally cast (CC) Nickel-or Cobalt-based super alloys could also be treated with the disclosed method.

The solution heated component is preferable a gas turbine component with an internal cooling channel, preferably a turbine blade with an airfoil part with low thermal inertia and a root part with a large thermal inertia, a vane with an airfoil part with low thermal inertia and 2 or 1 platform parts with a large thermal inertia or a heat shield.

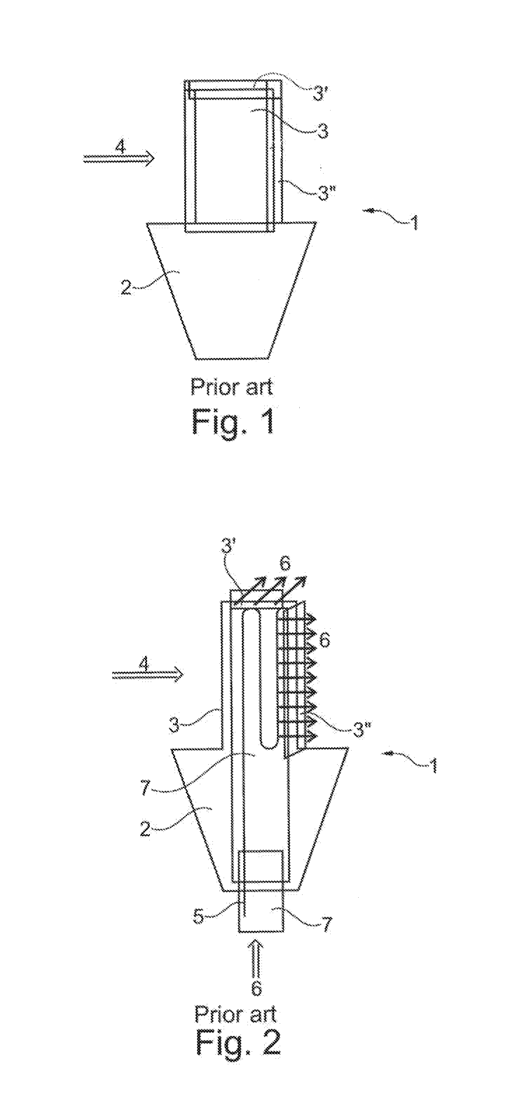

FIG. 1 shows a simplified sketch of such a cast component 1 according to known prior art. The component 1 in FIG. 1 is a turbine blade comprising a first part 2 with a large thermal inertia (=root) and a second part 3 with a low thermal inertia (=airfoil) according to the known prior art. The airfoil 3 comprises a tip section 3′ and a trailing edge section 3″. The hot gas flow direction in the turbo machine is shown as an arrow 4. Subjecting such a component 1 to a usual known solution heat treatment in a furnace for achieving good mechanical properties leads to a non-uniform temperature distribution in the component because of the faster cooling and/or heating of the thin sections (second part 3, here the airfoil of the turbine blade 1 with a lower thermal mass) and comparatively slow cooling and/or heating of the thick sections (first part 2, here the root of the turbine blade 1, which could be for example a fir-tree and shank of the blade) with a large thermal mass. There could be a risk of plastic deformation (primary during cooling) and/or overheating during heat-up in the component due to the excessive local temperature gradients. Furthermore, during cooling the minimum required cooling rate may not be achieved in a thick section causing insufficient material properties in the thick section (e.g. yield strength). Additionally, there could be a risk that a hold time in a thick section of a component is too short to achieve required material properties, as during heat-up a thin section reaches the hold temperature earlier than a thick section.

FIG. 2 shows a simplified cooling scheme for such a cast turbine blade according to the prior art. During operation of the turbo machine the component 1 (blade) is cooled by cooling air 6. The turbine blade according to FIG. 2 comprises therefore an internal cooling channel 5 which extends from the root (first part 2 with a large thermal inertia) to the tip section 3′ of the airfoil 3 (second part 3 with a low thermal inertia), changes two times the direction within the airfoil and comprises openings in the tip section 3′ for blade tip cooling as indicated by arrows and openings in the trailing edge section 3″ for blade trailing edge cooling, also indicated by arrows. Cooling air 6 flows through said channel 5 as described.

The solution heat treatment of that component is for example done with a ceramic core 7 comprising a complex internal geometry and possibly with shell mould remainders, or alternatively without a core 7 and without shell mould. Even though not fully opened after casting the component 1 provides a cooling flow channel 5 (not shown in FIG. 1). If the core 7 has been removed, the core inlet and exit print outs provide a flow channel 5.

During operation (when the blade/component 1 is used in the turbo machine) the component 1 forms together with similar neighbouring components 1 an external (hot gas flow 4) channel to channel flow in the intended flow direction and extract work, or to prevent flow to flow in a certain flow direction.

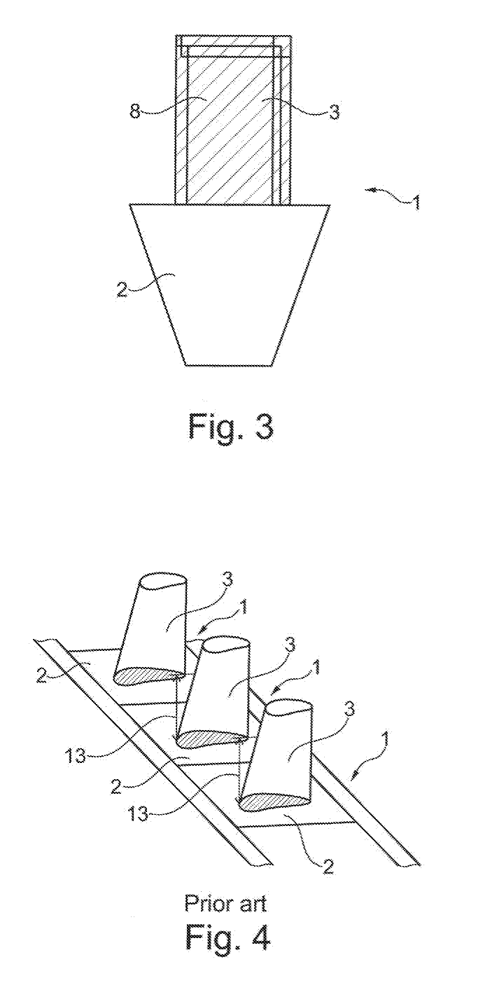

FIG. 3 shows in a simplified embodiment of the invention the turbine blade 1, made of a Nickel-based super alloy, with a wrapped airfoil (second part 3). The first part 2 (root with high thermal inertia) is not covered with the additional material 8. The wrapping material 8, for example a ceramic felt, ceramic wool or ceramic textile, increases the thermal inertia of the second part 3 and homogenises the temperature distribution over the component during the heat treatment. The results depend on the chosen thickness of the material 8, its thermal conductivity, heat capacity, the location and the attachment method.

FIG. 4 shows schematically an assembly of three turbine blades (three components 1) in a turbo machine. Each of the three neighbouring components comprise a root (first part 2 with large thermal inertia) and an airfoil (second part 3 with a low thermal inertia). There is a repeating throat area 13 between them. The components 1 provide (together with other parts of the turbo machine) when assembled in the machine a hot gas flow channel.

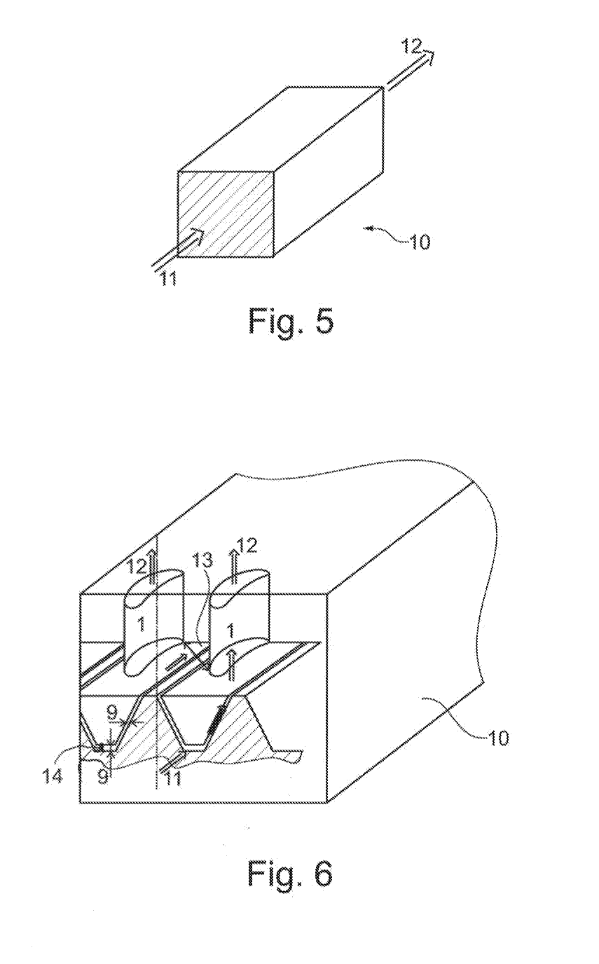

In a perspective drawing a simplified drawer 10 for installation in the solution heat treatment furnace is shown in FIG. 5. The drawer 10 comprises an inert gas flow inlet 11 and an inert gas flow outlet 12. Several of such drawers 10 could be installed in the furnace and a plurality of components 1 is separated by using several of said drawers 10. There is a pressure difference of the inert gas between the inert gas flow inlet 11 and the inert gas flow outlet 12 of the drawer 10 provided for a controlled flow situation. In addition, a pressure difference of the inert gas between the inert gas flow inlet 11 and the inert gas flow outlet 12 of the internal cooling channel 5 of the component 1 (not shown in FIG. 5) is provided for a controlled flow situation.

The disclosed solution heat treatment method is used for manufacturing metallic components 1 of a turbo machine, which components 1 provide a hot gas flow channel when assembled in the turbo machine after manufacturing, wherein the components 1 are subjected to a time-temperature-cycle in a furnace. The method comprises the following steps.
positioning the components 1 in the furnace in the same principle as the component assembly in the turbo machine, but leaving flow areas and gaps 9 between neighbouring components 1, then
starting the time-temperature-cycle and
applying an inert gas during the solution heat treatment process, so that the inert gas flows through said flow areas and gaps 9 for achieving a uniform temperature at any time in the solution heat treatment process, in particular during rapid cool-down and heat-up phases.

This “external” inert gas flow decreases the mismatches in flow conditions within the furnace, so that a more uniform temperature distribution and therefore improved mechanical properties of the treated components 1 are achieved. This is for example applicable when cast components 1 with ceramic cores 7 inside are solution heat treated.

A further advantage of the inventions is realized when components 1 are solution heat treated according to the described method, wherein said components 1 comprise at least one internal cooling channel 5, so that—while applying the inert gas during the solution heat treatment process in the furnace—said inert gas flows also through that internal channel 5. This is for example the case when the ceramic core 7 which was used in the casting process of the component is removed thereby producing such an internal cooling channel 5. The combination of this “internal” flow with the described “external” flow decreases further the mismatches in the flow conditions.

In one embodiment of the described invention, wherein each component 1 comprises at least a first part 2 with a first thermal inertia and at least a second part 3 with a second thermal inertia, wherein the first thermal inertia is significantly higher than the second thermal inertia, the second part 3 of each component 1 is wrapped with a wrapping material 8 before positioning the partly wrapped components in the furnace for solution heat treatment. The wrapping material 8, preferably ceramic felt, ceramic wool or ceramic textile, increases the thermal inertia of the second part. Thermal conductivity, thickness, location and attachment method of the ceramic material could be easily chosen to achieve the best results.

As described above and shown in FIG. 5 a drawer 10 with the components 1 arranged in that drawer 10 is preferably used in the furnace. The drawer allows a controlled flow situation in the furnace.

FIG. 6 shows a drawer design in detail with two turbine blades (components 1) according to a further embodiment of the invention. The placement of the components in the furnace/drawer is to be arranged using the same principle as the component assembly in the turbo machine during operation. As can be seen in FIG. 6 the used drawer 10 comprises a dedicated internal design which is matched to the design of the components 1 to be solution heat treated, that means for example to the as cast component 1. A plurality of components 1 could be separated by using several of said drawers 10. Each of said components 1 is fixed to the drawer 10 by any suitable detachable fixture means 14, for example by metallic wire or by blocks, for metallic blocks a ceramic interface piece to avoid diffusion bonding to a component 1 is provided, so that an unintended movement during the furnace run is not possible. Each component type has got dedicated drawers and fixtures to be matched to the as cast component. Each component type needs throat 13, flow areas and gaps 9 and an inert gas design in such a way that a uniform thermal inertia of the component is achieved and therefore process variations are reduced and variations in material properties, for example in the yield strength from component to component or within a component are decreased resp. avoided. The drawers 10 ensure that the use of the hot gas path and the cooling flow paths are used.

The drawers 10 ensure that all components 1 obtain a similar inert gas flow. For components on the outer edges a fixture side wall needs to match the pressure/suction side of the component. There is a pressure difference of the inert gas between the inert gas flow inlet 11 and the inert gas flow outlet 12 of the drawer 10 provided for a controlled flow situation.

Internal cooling channels (not shown in FIG. 6) provide an additional inert gas flow with the advantages described above. In addition, wrapping the airfoils (second part 3) of the components 1 with wrapping material 8 (also not shown in FIG. 6) further limits the significant mismatch of thermal inertia between the airfoil and the root and contributes therefore to a further homogenisation of temperature. The wrapping material 8 is preferred of uniform thickness across the airfoil to maintain the flow path.

In case the thermal mismatch between the first and the second part of the component 1 is not significant there is of course no need to wrap parts of the component 1 during solution heat treatment. In such cases the method as disclosed in independent claim 1 or the method as disclosed in dependent claim 2 should be applied to the components.

With the disclosed method it is possible to realize that the components are subjected to nearly the same flow and thermal conditions in the furnace, therefore the variation in material properties (for example the yield strength) is decreased from component to component and within a component.

### LIST OF REFERENCE NUMERALS

1 component, for example turbine blade, vane, heat shield
2 first part, for example root
3 second part, for example airfoil
3′ tip section of the airfoil
3″ trailing edge section of the airfoil
4 hot gas flow direction in the turbo machine
5 internal cooling channel
6 cooling air
7 core (made of ceramic material)
8 wrapping material, for example ceramic felt

9 gap

10 drawer

11 inert gas flow inlet

12 inert gas flow outlet

13 throat area

14 fixture means

1. Solution heat treatment method for manufacturing metallic components of a turbo machine, which components provide a hot gas flow channel when assembled in the turbo machine after manufacturing, wherein the components are subjected to a time-temperature-cycle in a furnace, the method comprising:
positioning components in a furnace according to their component assembly in the turbo machine, but leaving flow areas and gaps between neighbouring components; then
starting a time-temperature-cycle; and
applying an inert gas during a solution heat treatment process, so that the inert gas will flow through said flow areas and gaps for achieving a uniform temperature at any time in the solution heat treatment process, including during rapid cool-down and heat-up phases.

2. The method according to claim 1, wherein the components comprise:
at least one internal cooling channel, so that while applying the inert gas during the solution heat treatment process said inert gas flows also through that internal channel.

3. The method according to claim 1, wherein each component includes at least a first part with a first thermal inertia and at least second part with a second thermal inertia, wherein the first thermal inertia is significantly higher than the second thermal inertia, the method comprising:
wrapping the second part of each component with a wrapping material before positioning the partly wrapped components in the furnace for solution treatment, whereby the wrapping material creases a thermal inertia of the second part.

4. The method according to claim 3, wherein the wrapping material is one the group of ceramic felt, ceramic wool, ceramic textile.

5. The method according to claim 1, comprising:
positioning said components in the furnace within at least one drawer having an inert gas flow inlets and an inert gas flow outlet.

6. The method acceding to claim 5, wherein a plurality of components is separated by using several of said drawers.

7. The method according to claim 5, wherein a pressure difference of the inert gas between the inert gas flow inlet and the inert gas flow outlet of the drawer is provided for a controlled flow situation.

8. The method according to claim 2, wherein a pressure difference of the inert gas between the inert gas flow inlet and the inert gas flow outlet of the internal cooling channel of the component provided for a controlled flow situation.

9. The method according to claim 5, wherein the used drawers comprise a dedicated internal design which is at least partly matched to a design of the components to be solution heat treated.

10. The method according to claim 9, wherein the component is fixed to the drawer by any suitable detachable fixture means.

11. The method according to claim 1, wherein the solution heated component is a gas turbine component a turbine blade, a vane or a heat shield.

12. The method according to claim 1, wherein the components are made of a conventionally cast (CC) super alloy such as a Nickel- or Cobalt-based super alloy.

13. The method according to claim 1, wherein the components are made of a single crystal (SX) or directionally solidified (DS) super alloy, such as a Nickel- or Cobalt-based super alloy.
